(19) United States
(12) Patent Application Publication
(10) Pub. No.: US 2026/0356169 A1
(43) Pub. Date: Nov. 12, 2026

(54) HEAT PUMP SYSTEM FOR A VEHICLE

(71) Applicants: HYUNDAI MOTOR COMPANY, Seoul (KR); KIA CORPORATION, Seoul (KR); Seoul National University R&DB Foundation, Seoul (KR)

(72) Inventors: Man Hee Park, Hwaseong-si (KR); Hochan An, Hwaseong-si (KR); Yeon Ho Kim, Hwaseong-si (KR); Jeawan Kim, Hwaseong-si (KR); Gwi Taek Kim, Hwaseong-si (KR); Yeong Jun Kim, Hwaseong-si (KR); Jae Yeon Kim, Hwaseong-si (KR); Hoyoung Jeong, Hwaseong-si (KR); Min Soo Kim, Seoul (KR); Seungyeon Lee, Seoul (KR); Jaegyun Jang, Seoul (KR); Inchan Hwang, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/385,836

(22) Filed: Nov. 11, 2025

(30) Foreign Application Priority Data
May 9, 2025 (KR) 10-2025-0060633

(51) Int. Cl. B60H 1/32

(52) U.S. Cl. CPC B60H 1/3228

(57) ABSTRACT

A heat pump system for a vehicle is provided. The heat pump system for the vehicle is capable of maximizing the cooling and heating performance by operating in both of a supercritical region and a subcritical region in which the pressure and/or temperature of the refrigerant is higher than a critical pressure and/or temperature, by applying R744 refrigerant, which is a natural refrigerant utilizing carbon dioxide.

### CROSS-REFERENCE TO RELATED APPLICATION

This application claims priority to and the benefit of Korean Patent Application No. 10-2025-0060633 under 35 U.S.C. § 119, filed on May 9, 2025, in the Korean Intellectual Property Office, the entire contents of which are incorporated herein by reference.

### FIELD

The present disclosure relates to a heat pump system for a vehicle.

### BACKGROUND

Generally, an air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

The above information disclosed in this Background section is only for enhancement of understanding of the background of the disclosure, and therefore it may contain information that does not form the prior art that is already known to a person having ordinary skill in the art.

### SUMMARY

The present disclosure provides a heat pump system for a vehicle capable of performing cooling or heating of a vehicle interior using a natural refrigerant and lowering the temperature of a refrigerant discharged from a compressor, so as to correspond to environmental regulations.

The present disclosure provides a heat pump system for a vehicle capable of maximizing the cooling and heating performance by operating in both of a supercritical region and a subcritical region in which the pressure and/or temperature of the refrigerant is higher than a critical pressure and/or temperature, by applying R744 refrigerant, which is a natural refrigerant utilizing carbon dioxide.

According to an aspect of the present disclosure, a heat pump system for a vehicle includes at least one compressor, a first heat-exchanger, a second heat-exchanger, a first expansion valve, and a third heat-exchanger, which are connected through a refrigerant line so as to circulate a refrigerant through the refrigerant line; a chiller connected to the refrigerant line through a first connection line, and configured to adjust a temperature of a coolant by exchanging heat between a supplied refrigerant and the coolant, a second expansion valve provided on the first connection line, a third expansion valve provided on the refrigerant line which is disposed between the third heat-exchanger and the compressor, a second connection line including a first end connected to the refrigerant line which is disposed between the first heat-exchanger and the second heat-exchanger, and a second end connected to the refrigerant line which is disposed between the second heat-exchanger and the third heat-exchanger, a fourth expansion valve provided on the second connection line, a third connection line including a first end connected to the refrigerant line which is disposed between the compressor and the first heat-exchanger, and a second end connected to the refrigerant line which is disposed between the first heat-exchanger and the second heat-exchanger, and a compressor cooling device connected to the at least one compressor configured to cool a partial refrigerant among the refrigerant compressed in the at least one compressor, and to supply the cooled refrigerant to the at least one compressor.

The compressor cooling device may include a cooler configured to cool the refrigerant supplied from the at least one compressor, a first cooler connection line disposed at a location close to a portion where the refrigerant is introduced into the at least one compressor, and including a first end connected to the at least one compressor and a second end connected to the cooler, and a second cooler connection line disposed at a location close to a portion where the refrigerant is discharged from the at least one compressor, and including a first end connected to the at least one compressor and a second end connected to the cooler.

The cooler may be configured to exchange heat between the refrigerant introduced through the first cooler connection line and the coolant or an ambient air.

The cooler may be integrally formed with the second heat-exchanger.

The at least one compressor may include a first compressor disposed on the refrigerant line at a downstream end of an evaporator, based on a flow direction of the refrigerant, and a second compressor provided on the refrigerant line at a downstream end of the first compressor.

The compressor cooling device may include a cooler configured to cool a partial refrigerant supplied from the first compressor, a first cooler connection line including a first end connected to the first compressor and a second end connected to the cooler, so as to introduce the partial refrigerant supplied from the first compressor into the cooler, and a second cooler connection line including a first end connected to the second compressor and a second end connected to the cooler, so as to introduce the refrigerant cooled in the cooler into the second compressor.

The first compressor may be disposed on the refrigerant line at a downstream end of the evaporator, based on a flow direction of the refrigerant.

The first compressor and the second compressor may be serially connected through the refrigerant line.

The second compressor may be configured to additionally compress the refrigerant introduced through the refrigerant line after being compressed in the first compressor.

The compressor cooling device may receive the refrigerant from the first compressor and cool the received refrigerant while the first compressor compresses the refrigerant.

The second compressor may be disposed on the refrigerant line at a downstream end of the first compressor.

The compressor cooling device may further include a first valve provided on the refrigerant line which is disposed between the first heat-exchanger and the second heat-exchanger, a second valve provided on the third connection line, a fourth connection line including a first end connected to the refrigerant line which is disposed between the second heat-exchanger and the third heat-exchanger, and a second end connected to the refrigerant line which is disposed between the third heat-exchanger and the third expansion valve, and a fifth expansion valve provided on the fourth connection line.

The first expansion valve, the second expansion valve, the third expansion valve, the fourth expansion valve, and the fifth expansion valve may be electronic expansion valves configured to selectively expand the refrigerant, while controlling a flowing movement of the refrigerant.

The compressor cooling device may further include a fifth connection line including a first end connected to the refrigerant line which is disposed between the third heat-exchanger and the compressor, and a second end connected to the refrigerant line which is disposed between the first heat-exchanger and the second heat-exchanger, and a third valve provided on the fifth connection line.

The compressor cooling device may further include an accumulator provided on the refrigerant line which is disposed between the third heat-exchanger and the compressor, and an internal heat-exchanger provided in an interior of the accumulator, and configured to heat-exchange the refrigerant supplied from the second heat-exchanger and the refrigerant supplied from the third heat-exchanger with each other, and to supply the higher-temperature refrigerant among the heat-exchanged refrigerant to the third heat-exchanger.

The second heat-exchanger and the third heat-exchanger may be configured to cool or evaporate an interiorly introduced refrigerant.

A first end of the first connection line may be connected to the refrigerant line which is disposed between the second heat-exchanger and the first expansion valve, and a second end of the first connection line may be connected to the refrigerant line which is disposed between the third heat-exchanger and the compressor.

The refrigerant may be an R744 refrigerant formed of carbon dioxide.

The chiller may be respectively connected to an electrical component and a battery module through a first line and a second line through which the coolant circulates.

The first heat-exchanger, the second heat-exchanger, and the third heat-exchanger may be air-cooled gas coolers configured to heat-exchange an interiorly introduced refrigerant with air, and the chiller may be a water-cooled gas cooler configured to heat-exchange the interiorly introduced refrigerant with the coolant.

As described above, according to a heat pump system for a vehicle according to an embodiment, cooling or heating of vehicle interior may be performed using a natural refrigerant, thereby enabling compliance with environmental regulations, and improving the overall marketability of vehicle.

According to the present disclosure, by operating in both of a supercritical region and a subcritical region in which the pressure and/or temperature of the refrigerant is higher than a critical pressure and/or temperature at the time of cooling and heating the vehicle interior, by applying R744 refrigerant, which is a natural refrigerant utilizing carbon dioxide, the cooling and heating performance can be maximized.

According to an embodiment, by lowering the temperature of a refrigerant discharged from a compressor using a compressor cooling device, the coefficient of performance (COP), which is a coefficient of cooling capability compared to a required compressor power, as well as the cooling performance, may be improved.

According to the present disclosure, by efficiently adjust the temperature of the battery module depending on the mode of the vehicle using a single chiller where the coolant and the refrigerant are heat-exchanged with each other, streamlining and simplification of the system may be achieved.

According to the present disclosure, by efficiently adjusting the temperature of the battery module, the optimal performance of the battery module may be obtained, and the overall travel distance of the vehicle may be increased through the efficient management of battery module.

According to the present disclosure, through streamlining of an entire system, it is possible to reduce manufacturing cost and weight and improve space utilization.

It is to be understood that both the foregoing general description and the following detailed description are exemplary and explanatory and are intended to provide further explanation of the disclosure as claimed.

### BRIEF DESCRIPTION OF THE DRAWINGS

FIG. 1 is a schematic block diagram of a heat pump system for a vehicle according to an embodiment.

FIG. 2 is an enlarged schematic view of a portion A of FIG. 1 according to an embodiment.

FIG. 3 is an enlarged schematic view of a portion A of FIG. 1 according to another embodiment.

FIG. 4 is an enlarged schematic view of a portion A of FIG. 1 according to still another embodiment.

### DETAILED DESCRIPTION

Various modifications may be made to the embodiments. The embodiments are not construed as limited to the disclosure and should be understood to include all changes, equivalents, and replacements within the idea and the technical scope of the disclosure.

Embodiments disclosed in the present specification and the constructions depicted in the drawings are only exemplary and do not cover the entire scope of the present disclosure. Therefore, it is understood that there may be various equivalents and variations at the time of the application of this specification.

In order to clarify the present disclosure, parts that are not related to the description is omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “unit,” “portion,” “part,” and the like may be used to describe various components, but the components should not be limited by the terms. The above-described terms may refer to a term indicating not only a physically/visually distinct component, but also a function or component of a corresponding portion even in case that not clearly divided or partitioned.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

Hereinafter, some embodiments of the present disclosure are described in more detail with reference to the accompanying drawings.

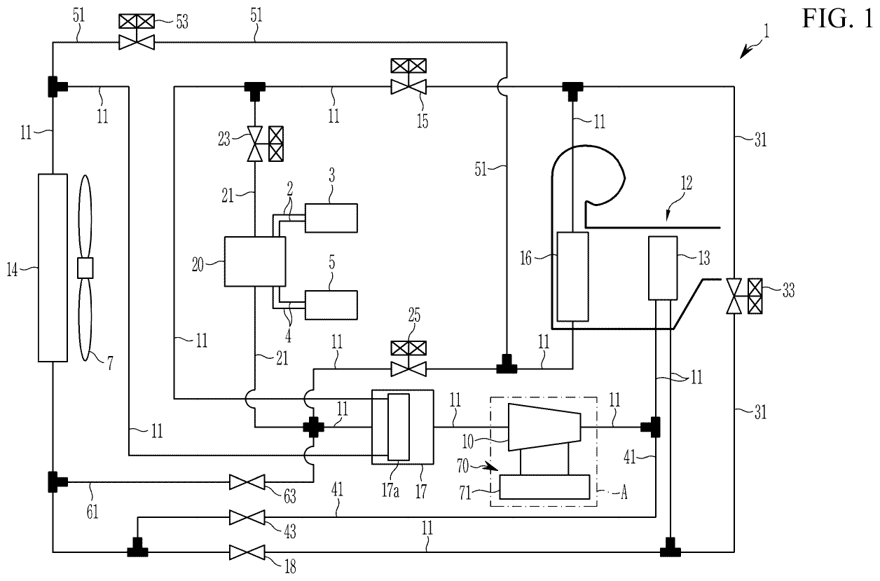

FIG. 1 is a schematic block diagram of a heat pump system for a vehicle according to an embodiment.

A heat pump system 1 for a vehicle according to an embodiment may perform cooling or heating of a vehicle interior using a natural a refrigerant so as to correspond to environmental regulations, lower temperature of the refrigerant discharged from a compressor 10, and efficiently adjust a temperature of a battery module 5 using one chiller 20 through which the refrigerant and a coolant are heat-exchanged.

The refrigerant may be an R744 refrigerant formed of carbon dioxide, which has an ozone depletion potential (ODP) of 0 and a global warming potential (GWP) of 1.

In particular, the heat pump system 1 for a vehicle according to an embodiment, by operating in both of a supercritical region and a subcritical region in which the pressure and/or temperature of the refrigerant is higher than a critical pressure and/or temperature, by applying the R744 refrigerant, which is a natural refrigerant utilizing carbon dioxide, the cooling and heating performance can be maximized.

For such a purpose, the heat pump system 1 according to an embodiment may include at least one compressor 10, a first heat-exchanger 13, a second heat-exchanger 14, a first expansion valve 15, a third heat-exchanger 16, an accumulator 17, an internal heat-exchanger 17a, and the chiller 20, which are connected through the refrigerant line 11 so as to circulate a refrigerant through a refrigerant line 11.

In an embodiment, the at least one compressor 10 may be connected to the first-heat exchanger 13, which is connected to the second heat-exchanger 14 and the accumulator 17. The first expansion valve 15 may be connected to the third heat-exchanger 16. The chiller 20 may be connected to the accumulator 17,

Firstly, the at least one compressor 10 may compress the introduced refrigerant and allow the compressed refrigerant to flow to the refrigerant line 11 so that the refrigerant circulates along the refrigerant line 11.

In the heat pump system 1 according to an embodiment, the at least one compressor 10 may be composed of a single compressor.

The first heat-exchanger 13 may heat-exchange the refrigerant selectively supplied from the compressor 10 with air.

The second heat-exchanger 14 may be connected to the first heat-exchanger 13 through the refrigerant line 11. Accordingly, the refrigerant supplied into the refrigerant line 11 may pass through the second heat-exchanger 14.

The second heat-exchanger 14 may be disposed at the front of the vehicle and may cool or evaporate the refrigerant through heat-exchange with the air introduced from the outside during driving of the vehicle. A cooling fan 7 may be provided on a downstream side of the second heat-exchanger 14. For example, the cooling fan 7 may be disposed behind the second heat exchanger 14.

Since the R744 refrigerant does not have a phase change unlike the typical refrigerant, the term “gas cooling” may be used instead of the term “condensation”.

In an embodiment, the first expansion valve 15 may be provided on the refrigerant line 11 which is disposed between the second heat-exchanger 14 and the third heat-exchanger 16. The first expansion valve 15 may selectively expand the refrigerant introduced through the refrigerant line 11.

In particular, the first expansion valve 15 may selectively expand the refrigerant while controlling a flowing movement of the refrigerant.

The third heat-exchanger 16 may be provided on the refrigerant line 11 which is disposed between the first expansion valve 15 and the compressor 10.

The first heat-exchanger 13 and the third heat-exchanger 16 may be provided in an interior of a heating, ventilation, and air-conditioning (HVAC) module 12.

Accordingly, the third heat-exchanger 16 may cool or evaporate the refrigerant through heat-exchange with the air introduced into the HVAC module 12.

In particular, the first heat-exchanger 13, the second heat-exchanger 14, and the third heat-exchanger 16 may be air-cooled gas coolers configured to heat-exchange the interiorly introduced refrigerant with air.

The second heat-exchanger 14 and the third heat-exchanger 16 may evaporate the refrigerant in case that the expanded refrigerant is introduced and may cool the refrigerant in case that the unexpanded refrigerant is introduced.

In an embodiment, the accumulator 17 may be provided on the refrigerant line 11 which is disposed between the third heat-exchanger 16 and the compressor 10.

The accumulator 17 may supply only the gaseous refrigerant to the compressor 10, thereby improving the efficiency and durability of the compressor 10.

The internal heat-exchanger 17a which is disposed in the accumulator 17 may be provided in an interior of the accumulator 17. The internal heat-exchanger 17a may heat-exchange the refrigerant supplied from the second heat-exchanger 14 and the refrigerant supplied from the third heat-exchanger 16 with each other and may supply the higher-temperature refrigerant among the heat-exchanged refrigerant to the third heat-exchanger 16.

In particular, the internal heat-exchanger 17a may heat-exchange the refrigerant cooled in the second heat-exchanger 14 with the low-temperature refrigerant discharged from the third heat-exchanger 16 and may supply the heat-exchanged refrigerant to the third heat-exchanger 16 and the compressor 10, respectively.

In an embodiment, the chiller 20 may be connected to an electrical component 3 through a first line 2 through which the coolant circulates.

The electrical component 3 may include a power conversion device such as an electric power control unit (EPCU), motor, inverter, or an on-board charger (OBC), as well as an autonomous driving controller, or the like.

The electrical component 3 may be connected to the first line 2, to be cooled in a water-cooled manner.

On the other hand, the chiller 20 may adjust a temperature of the electrical component 3 using the coolant heat-exchanged with the refrigerant and may recollect a waste heat of the electrical component 3.

The chiller 20 may be connected to the battery module 5 through a second line 4 through which the coolant circulates. Accordingly, the coolant may selectively circulate through the chiller 20.

The chiller 20 may adjust a temperature of the coolant by heat-exchanging a supplied refrigerant with the coolant. In particular, the chiller 20 may be a water-cooled gas cooler configured to heat-exchange the interiorly introduced refrigerant with the coolant.

On the other hand, the chiller 20 may be connected to the refrigerant line 11 through a first connection line 21.

A first end of the first connection line 21 may be connected to the refrigerant line 11 which is disposed between the second heat-exchanger 14 and the first expansion valve 15. A second end of the first connection line 21 may be connected to the refrigerant line 11 which is disposed between the third heat-exchanger 16 and the accumulator 17.

In particular, the chiller 20 may adjust the temperature of the coolant by heat-exchanging the coolant selectively introduced through the first line 2, or the second line 4 with the selectively supplied refrigerant.

Accordingly, the coolant heat-exchanged in the chiller 20 may circulate the electrical component 3 through the first line 2. The coolant heat-exchanged in the chiller 20 may circulate the battery module 5 through the second line 4.

On the other hand, a water pump (not shown) may be provided on the first line 2 and the second line 4.

In particular, the coolant may circulate along the first line 2 and the second line 4 according to an operation of each water pump (not shown).

Accordingly, the coolant heat-exchanged with the refrigerant in the chiller 20 may adjust the temperature of the electrical component 3 and the battery module 5, while being selectively supplied to the electrical component 3 and the battery module 5.

On the other hand, the heat pump system 1 may further include a first valve 18, a second expansion valve 23, a third expansion valve 25, a second connection line 31, a fourth expansion valve 33, a third connection line 41, a second valve 43, a fourth connection line 51, a fifth expansion valve 53, a fifth connection line 61, a third valve 63, and a compressor cooling device 70.

Firstly, the first valve 18 may be provided on the refrigerant line 11 which is disposed between the first heat-exchanger 13 and the second heat-exchanger 14.

The first valve 18 may selectively open and close the refrigerant line 11 so that the refrigerant discharged from the first heat-exchanger 13 is selectively introduced into the second heat-exchanger 14.

In an embodiment, the second expansion valve 23 may be provided on the first connection line 21.

The second expansion valve 23 may selectively expand the refrigerant introduced into the first connection line 21 and allow the expanded refrigerant to flow into the chiller 20 depending on the selected air conditioning mode of the vehicle interior.

The second expansion valve 23 may supply the refrigerant introduced into the first connection line 21 to the chiller 20 without expansion or may close the first connection line 21 so that the refrigerant is not supplied to the chiller 20.

In more detail, in case that the battery module 5 is to be cooled in the chiller 20 using the coolant heat-exchanged with the refrigerant, the second expansion valve 23 may open the first connection line 21. Simultaneously, the second expansion valve 23 may expand the refrigerant introduced into the first connection line 21 and allow the expanded refrigerant to flow into the chiller 20.

In particular, the second expansion valve 23 may expand the refrigerant discharged from the second heat-exchanger 14 to lower its temperature and allow the expanded refrigerant to flow into the chiller 20, thereby further lowering the temperature of the coolant passing through the interior of the chiller 20.

Accordingly, the coolant cooled while passing through the chiller 20 may be introduced into the battery module 5, thereby achieving more efficient cooling.

The third expansion valve 25 may be provided on the refrigerant line 11 which is disposed between the third heat-exchanger 16 and the compressor 10. In more detail, the third expansion valve 25 may be provided on the refrigerant line 11 between the third heat-exchanger 16 and the accumulator 17.

The third expansion valve 25 may allow the refrigerant introduced through the refrigerant line 11 to selectively flow in an expanded or unexpanded state depending on the selected air conditioning mode of the vehicle interior.

In particular, the third expansion valve 25 may selectively expand the refrigerant, while controlling the flowing movement of the refrigerant.

In an embodiment, a first end of the second connection line 31 may be connected to the refrigerant line 11 which is disposed between the first heat-exchanger 13 and the second heat-exchanger 14. A second end of the second connection line 31 may be connected to the refrigerant line 11 which is disposed between the second heat-exchanger 14 and the third heat-exchanger 16.

The fourth expansion valve 33 may be provided on the second connection line 31. The fourth expansion valve 33 may selectively open and close the second connection line 31 and may selectively expand the refrigerant introduced into the second connection line 31.

Here, in a cooling mode of the vehicle interior, the fourth expansion valve 33 may close the second connection line 31. On the other hand, in a heating mode of the vehicle interior, the fourth expansion valve 33 may open the second connection line 31.

In addition, in a heating-and-dehumidifying mode of the vehicle interior, the fourth expansion valve 33 may open the second connection line 31 and may expand the refrigerant introduced into the second connection line 31.

In particular, the fourth expansion valve 33 may selectively expand the refrigerant, while controlling the flowing movement of the refrigerant.

In an embodiment, a first end of the third connection line 41 may be connected to the refrigerant line 11 which is disposed between the compressor 10 and the first heat-exchanger 13. A second end of the third connection line 41 may be connected to the refrigerant line 11 which is disposed between the first heat-exchanger 13 and the second heat-exchanger 14.

The second valve 43 may be provided on the third connection line 41. The second valve 43 may selectively open and close the third connection line 41.

In particular, in the cooling mode of the vehicle interior, the second valve 43 may open the third connection line 41. On the other hand, in the heating mode of the vehicle interior and the heating-and-dehumidifying mode of the vehicle interior, the second valve 43 may close the third connection line 41.

A first end of the fourth connection line 51 may be connected to the refrigerant line 11 which is disposed between the second heat-exchanger 14 and the third heat-exchanger 16. A second end of the fourth connection line 51 may be connected to the refrigerant line 11 which is disposed between the third heat-exchanger 16 and the accumulator 17.

The fifth expansion valve 53 may be provided on the fourth connection line 51.

The fifth expansion valve 53 may selectively open and close the fourth connection line 51 to control the flowing movement of the refrigerant and may selectively expand the refrigerant introduced into the fourth connection line 51.

In particular, in the heating mode of the vehicle interior, the fifth expansion valve 53 may open the fourth connection line 51 and may expand the refrigerant introduced into the fourth connection line 51 and supply the expanded refrigerant to the second heat-exchanger 14 and the internal heat-exchanger 17a, respectively.

Accordingly, in the heating mode of the vehicle interior, the second heat-exchanger 14 may evaporate the refrigerant through heat-exchange with the air introduced from the outside.

On the other hand, the refrigerant having pass through the internal heat-exchanger 17a may be supplied to the chiller 20. At this time, the chiller 20 may evaporate the refrigerant through heat-exchange with the coolant supplied through the first line 2.

To the contrary, in the cooling mode of the vehicle interior, or the heating-and-dehumidifying mode of the vehicle interior, the fifth expansion valve 53 may close the fourth connection line 51.

In an embodiment, a first end of the fifth connection line 61 may be connected to the refrigerant line 11 which is disposed between the third heat-exchanger 16 and the compressor 10. A second end of the fifth connection line 61 may be connected to the refrigerant line 11 which is disposed between the first heat-exchanger 13 and the second heat-exchanger 14.

The third valve 63 may be provided on the fifth connection line 61. The third valve 63 may selectively open and close the fifth connection line 61 to control the flowing movement of the refrigerant.

Here, in the cooling mode of the vehicle interior, or the heating-and-dehumidifying mode of the vehicle interior, the third valve 63 may close the fifth connection line 61. To the contrary, in the heating mode of the vehicle interior, the third valve 63 may open the fifth connection line 61.

The first valve 18, the second valve 43, and the third valve 63 may be 2-way valves configured to control the opening and closing of the refrigerant line 11, the third connection line 41, and the fifth connection line 61.

The first expansion valve 15, the second expansion valve 23, the third expansion valve 25, the fourth expansion valve 33, and the fifth expansion valve 53 may be electronic expansion valves configured to selectively expand the refrigerant, while controlling the flowing movement of the refrigerant.

The compressor cooling device 70 according to an embodiment may receive some refrigerant from the compressor 10 and cool the received refrigerant while the compressor 10 compresses the refrigerant. Then, the compressor cooling device 70 may supply the cooled refrigerant back to the compressor 10.

Accordingly, the compressor cooling device 70 may lower the temperature of the refrigerant finally discharged from the compressor 10.

In particular, the compressor cooling device 70 may be connected to the compressor 10 to cool a partial refrigerant among the refrigerant compressed in the compressor 10 and to supply the cooled refrigerant to the compressor 10.

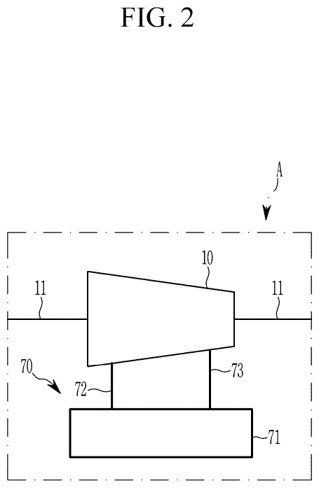

The configuration of the compressor cooling device 70 is described in detail with reference to FIG. 2.

FIG. 2 is an enlarged schematic view of a portion A of FIG. 1 and illustrates a block diagram of a compressor cooling device applied to a heat pump system for a vehicle according to an embodiment.

Referring to FIG. 2, the compressor cooling device 70 according to an embodiment may include a cooler 71, a first cooler connection line 72, and a second cooler connection line 73.

Firstly, the cooler 71 may cool the refrigerant supplied from the compressor 10.

A first end of the first cooler connection line 72 may be connected to the compressor 10 at a location close to a portion where the refrigerant is introduced into the compressor 10. A second end of the first cooler connection line 72 may be connected to the cooler 71.

A first end of the second cooler connection line 73 may be connected to the compressor 10 at a location close to a portion where the refrigerant is discharged from the compressor 10. A second end of the second cooler connection line 73 may be connected to the cooler 71.

The refrigerant pump (not shown) configured to force the refrigerant to flow may be provided on one among the cooler 71, or the first cooler connection line 72, or the second cooler connection line 73.

In the compressor cooling device 70, the cooler 71 may heat-exchange the refrigerant introduced through the first cooler connection line 72 from the compressor 10 with the coolant introduced through a separate coolant line, or an ambient air introduced from the outside during driving of the vehicle.

Accordingly, the refrigerant introduced into the cooler 71 may be cooled through heat-exchange with the coolant or the ambient air while passing through the cooler 71. Then, the refrigerant cooled in the cooler 71 may be introduced back into the compressor 10 through the second cooler connection line 73.

The refrigerant introduced back into the compressor 10 may be discharged to the refrigerant line 11 after compression is completed in the compressor 10.

In particular, in case that a partial refrigerant among the refrigerant undergoing early-stage compression in the compressor 10 is introduced, the compressor cooling device 70 may cool the introduced refrigerant using the coolant or the ambient air. Then, the compressor cooling device 70 may supply the cooled refrigerant to the compressor 10.

The compressor 10 may compress the refrigerant introduced from the compressor cooling device 70 together with the refrigerant being compressed therein.

By such an operation, a temperature of the refrigerant discharged from the compressor 10 to the refrigerant line 11 may be lowered.

In particular, the heat pump system 1 may prevent an excessive operation of the compressor 10 and reduce the cooling load at the same time, by applying the compressor cooling device 70.

Accordingly, the heat pump system 1 may improve the overall cooling performance, by enlarging the operation range of the compressor 10 in the high-load condition of the compressor 10.

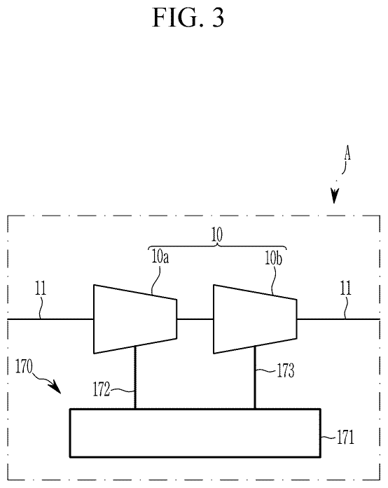

On the other hand, the compressor cooling device 170 according to another embodiment is described with reference to FIG. 3.

FIG. 3 is an enlarged schematic view of a portion A of FIG. 1 according to another embodiment. FIG. 3 illustrates a block diagram of a compressor cooling device applied to a heat pump system for a vehicle according to another embodiment.

Referring to FIG. 3, the at least one compressor 10 may include a first compressor 10a and a second compressor 10b. For example, the first compressor 10a and the second compressor 10b may be serially connected.

Firstly, the first compressor 10a may be disposed on the refrigerant line 11 at a downstream end of the evaporator 16, based on a flow direction of the refrigerant.

The second compressor 10b may be provided on the refrigerant line 11 at a downstream end of the first compressor 10a.

The second compressor 10b may additionally compress the refrigerant introduced through the refrigerant line 11 after being compressed in the first compressor 10a.

On the other hand, the downstream end of the evaporator 16, and the downstream end of the first compressor 10a may be set based on the flow direction of the refrigerant.

In particular, based on the direction along which the refrigerant flows through the refrigerant line 11, the position where the refrigerant is introduced into the evaporator 16 may be defined as an upstream end of the evaporator 16, and the location where the refrigerant is discharged from the evaporator 16 may be defined as the downstream end of the evaporator 16.

In addition, based on the direction along which the refrigerant flows through the refrigerant line 11, the position where the refrigerant is introduced into the first compressor 10a may be defined as an upstream end of the first compressor 10a, and the location where the refrigerant is discharged from the first compressor 10a may be defined as the downstream end of the first compressor 10a.

The compressor cooling device 170 according to another embodiment may receive some refrigerant from the first compressor 10a and cool the received refrigerant while the first compressor 10a compresses the refrigerant.

Then, the compressor cooling device 170 may supply the cooled refrigerant to the second compressor 10b.

Accordingly, the compressor cooling device 170 according to another embodiment may lower the temperature of the refrigerant finally discharged from the second compressor 10b.

In particular, the compressor cooling device 170 according to another embodiment may be connected to the first and second compressors 10a and 10b, respectively, to cool a partial refrigerant among the refrigerant compressed in the first compressor 10a, and to supply the cooled refrigerant to the second compressor 10b.

The compressor cooling device 170 may include a cooler 171, a first cooler connection line 172, and a second cooler connection line 173.

Firstly, the cooler 171 may cool the refrigerant supplied from the first compressor 10a.

A first end of the first cooler connection line 172 may be connected to the first compressor 10a so as to introduce a partial refrigerant supplied from the first compressor 10a into the cooler 170. A second end of the first cooler connection line 172 may be connected to the cooler 171.

A first end of the second cooler connection line 173 may be connected to the second compressor 10b so as to introduce the refrigerant cooled in the cooler 170 into the second compressor 10b. A second end of the second cooler connection line 173 may be connected to the cooler 171.

The refrigerant pump (not shown) configured to force the refrigerant to flow may be provided on one among the cooler 171, or the first cooler connection line 172, or the second cooler connection line 173.

In the compressor cooling device 170, the cooler 171 may heat-exchange the refrigerant introduced through the first cooler connection line 172 from the first compressor 10 with the coolant introduced through a separate coolant line, or the ambient air introduced from the outside during driving of the vehicle.

Accordingly, the refrigerant introduced into the cooler 171 may be cooled through heat-exchange with the coolant or the ambient air while passing through the cooler 171. Then, the refrigerant cooled in the cooler 171 may be introduced into the second compressor 10b through the second cooler connection line 173.

The refrigerant introduced into the second compressor 10b may be discharged to the refrigerant line 11 after compression is completed in the second compressor 10b.

In particular, in case that a partial refrigerant among the refrigerant undergoing compression in the first compressor 10a is introduced, the compressor cooling device 170 may cool the introduced refrigerant using the coolant or the ambient air. Then, the compressor cooling device 170 may supply the cooled refrigerant to the second compressor 10b.

The second compressor 10b may compress the refrigerant introduced from the compressor cooling device 170 together with the refrigerant being compressed therein.

By such an operation, a temperature of the refrigerant discharged from the second compressor 10b to the refrigerant line 11 may be lowered.

In particular, the heat pump system 1 according to another embodiment may prevent an excessive operation of the first and second compressors 10a and 10b and reduce the cooling load at the same time, by applying the compressor cooling device 170.

Accordingly, the heat pump system 1 according to another embodiment may improve the overall cooling performance, by enlarging the operation range of the first and second compressors 10a and 10b in the high-load condition of the first and second compressors 10a and 10b.

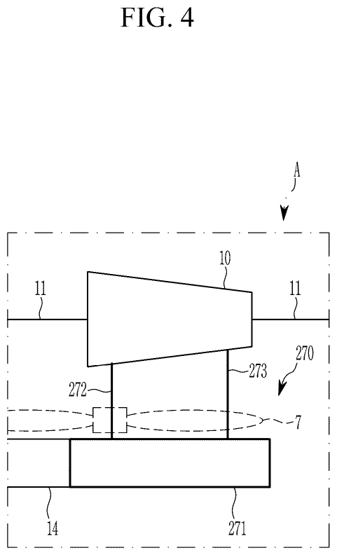

The compressor cooling device 270 according to still another embodiment is described with reference to FIG. 4.

FIG. 4 is an enlarged schematic view of a portion A of FIG. 1 according to still another embodiment. FIG. 4 illustrates a block diagram of a compressor cooling device applied to a heat pump system for a vehicle according to still another embodiment.

Referring to FIG. 4, the compressor cooling device 270 according to still another embodiment may be applied in case that the at least one compressor 10 is configured as a single compressor.

The compressor cooling device 270 according to still another embodiment may receive some refrigerant from the compressor 10 and cool the received refrigerant while the compressor 10 compresses the refrigerant. Then, the compressor cooling device 270 may supply the cooled refrigerant back to the compressor 10.

Accordingly, the compressor cooling device 270 may lower the temperature of the refrigerant finally discharged from the compressor 10.

In particular, the compressor cooling device 270 may be connected to the compressor 10, to cool a partial refrigerant among the refrigerant compressed in the compressor 10, and to supply the cooled refrigerant to the compressor 10.

The compressor cooling device 270 according to still another embodiment may include a cooler 271, a first cooler connection line 272, and a second cooler connection line 273.

Firstly, the cooler 271 may cool the refrigerant supplied from the compressor 10. The cooler 271 may be integrally formed with the second heat-exchanger 14.

A first end of the first cooler connection line 272 may be connected to the compressor 10 at a location close to a portion where the refrigerant is introduced into the compressor 10. A second end of the first cooler connection line 272 may be connected to the cooler 271.

A first end of the second cooler connection line 273 may be connected to the compressor 10 at a location close to a portion where the refrigerant is discharged from the compressor 10. A second end of the second cooler connection line 273 may be connected to the cooler 271.

The refrigerant pump (not shown) configured to force the refrigerant to flow may be provided on one among the cooler 271, or the first cooler connection line 272, or the second cooler connection line 273.

In the compressor cooling device 270, the cooler 271 may heat-exchange the refrigerant introduced through the first cooler connection line 272 from the compressor 10 with the ambient air introduced from the outside during driving of the vehicle.

Accordingly, the refrigerant introduced into the cooler 271 may be cooled through heat-exchange with the ambient air while passing through the cooler 271. Then, the refrigerant cooled in the cooler 271 may be introduced back into the compressor 10 through the second cooler connection line 273.

The refrigerant introduced back into the compressor 10 may be discharged to the refrigerant line 11 after compression is completed in the compressor 10.

In particular, in case that a partial refrigerant among the refrigerant undergoing early-stage compression in the compressor 10 is introduced, the compressor cooling device 270 may cool the introduced refrigerant using the ambient air. Then, the compressor cooling device 270 may supply the cooled refrigerant to the compressor 10.

The compressor 10 may compress the refrigerant introduced from the compressor cooling device 270 together with the refrigerant being compressed therein.

By such an operation, the temperature of the refrigerant discharged from the compressor 10 to the refrigerant line 11 may be lowered.

In particular, the heat pump system 1 according to still another embodiment may prevent the excessive operation of the compressor 10 and reduce the cooling load at the same time, by applying the compressor cooling device 270.

Accordingly, the heat pump system 1 may improve the overall cooling performance, by enlarging the operation range of the compressor 10 in the high-load condition of the compressor 10.

Therefore, as described above, in case that a heat pump system for a vehicle according to an embodiment is applied, cooling or heating of the vehicle interior may be performed using a natural refrigerant, thereby enabling compliance with environmental regulations, and improving the overall marketability of the vehicle.

According to the present disclosure, by operating in both of a supercritical region and a subcritical region in which the pressure and/or temperature of the refrigerant is higher than a critical pressure and/or temperature at the time of cooling and heating the vehicle interior, by applying R744 refrigerant, which is a natural refrigerant utilizing carbon dioxide, the cooling and heating performance can be maximized.

According to the present disclosure, by lowering the temperature of the refrigerant discharged from the compressor 10 using the compressor cooling devices 70, 170, and 270, the coefficient of performance (COP), which is a coefficient of cooling capability compared to a required compressor power, as well as the cooling performance, may be improved.

According to the present disclosure, by efficiently adjusting the temperature of the battery module 5 depending on the mode of the vehicle using the single chiller 20 where the coolant and the refrigerant are heat-exchanged with each other, streamlining and simplification of the system may be achieved.

According to the present disclosure, by efficiently adjusting the temperature of the battery module 5, the optimal performance of the battery module 5 may be obtained, and the overall travel distance of the vehicle may be increased through the efficient management of the battery module 5.

According to the present disclosure, through streamlining of an entire system, it is possible to reduce manufacturing cost and weight and improve space utilization.

Hereinabove, although the present disclosure has been described with reference to exemplary embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A heat pump system for a vehicle, the heat pump system comprising
at least one compressor, a first heat-exchanger, a second heat-exchanger, a first expansion valve, and a third heat-exchanger, which are connected through a refrigerant line so as to circulate a refrigerant through the refrigerant line;
a chiller connected to the refrigerant line through a first connection line and configured to adjust a temperature of a coolant by exchanging heat between a supplied refrigerant and the coolant;
a second expansion valve provided on the first connection line;
a third expansion valve provided on the refrigerant line which is disposed between the third heat-exchanger and the compressor;
a second connection line including:
a first end connected to the refrigerant line which is disposed between the first heat-exchanger and the second heat-exchanger, and
a second end connected to the refrigerant line which is disposed between the second heat-exchanger and the third heat-exchanger;
a fourth expansion valve provided on the second connection line;
a third connection line including:
a first end connected to the refrigerant line which is disposed between the compressor and the first heat-exchanger, and
a second end connected to the refrigerant line which is disposed between the first heat-exchanger and the second heat-exchanger; and
a compressor cooling device connected to the at least one compressor and configured to cool a partial refrigerant among the refrigerant compressed in the at least one compressor, and to supply the cooled refrigerant to the at least one compressor.

2. The heat pump system of claim 1, wherein the compressor cooling device includes:
a cooler configured to cool the refrigerant supplied from the at least one compressor;
a first cooler connection line disposed at a location close to a portion where the refrigerant is introduced into the at least one compressor, and including a first end connected to the at least one compressor and a second end connected to the cooler; and
a second cooler connection line disposed at a location close to a portion where the refrigerant is discharged from the at least one compressor, and including a first end connected to the at least one compressor and a second end connected to the cooler.

3. The heat pump system of claim 2, wherein the cooler is configured to exchange heat between the refrigerant introduced through the first cooler connection line and the coolant or an ambient air.

4. The heat pump system of claim 2, wherein the cooler is integrally formed with the second heat-exchanger.

5. The heat pump system of claim 1, wherein the at least one compressor includes:
a first compressor disposed on the refrigerant line at a downstream end of an evaporator based on a flow direction of the refrigerant; and
a second compressor provided on the refrigerant line at a downstream end of the first compressor.

6. The heat pump system of claim 5, wherein the compressor cooling device includes:
a cooler configured to cool a partial refrigerant supplied from the first compressor;
a first cooler connection line including: a first end connected to the first compressor, and a second end connected to the cooler so as to introduce the partial refrigerant supplied from the first compressor into the cooler; and
a second cooler connection line including: a first end connected to the second compressor, and a second end connected to the cooler so as to introduce the refrigerant cooled in the cooler into the second compressor.

7. The heat pump system of claim 5, wherein the first compressor is disposed on the refrigerant line at a downstream end of the evaporator, based on a flow direction of the refrigerant.

8. The heat pump system of claim 5, wherein the first compressor and the second compressor are serially connected through the refrigerant line.

9. The heat pump of claim 5, wherein the second compressor is configured to additionally compress the refrigerant introduced through the refrigerant line after being compressed in the first compressor.

10. The heat pump system of claim 5, wherein the compressor cooling device receives the refrigerant from the first compressor and cools the refrigerant while the first compressor compresses the refrigerant.

11. The heat pump of claim 7, wherein, the second compressor is disposed on the refrigerant line at a downstream end of the first compressor.

12. The heat pump system of claim 1, further comprising:
a first valve provided on the refrigerant line which is disposed between the first heat-exchanger and the second heat-exchanger;
a second valve provided on the third connection line;
a fourth connection line including:
a first end connected to the refrigerant line which is disposed between the second heat-exchanger and the third heat-exchanger, and
a second end connected to the refrigerant line which is disposed between the third heat-exchanger and the third expansion valve; and
a fifth expansion valve provided on the fourth connection line.

13. The heat pump system of claim 12, wherein the first expansion valve, the second expansion valve, the third expansion valve, the fourth expansion valve, and the fifth expansion valve are electronic expansion valves configured to selectively expand the refrigerant, while controlling a flowing movement of the refrigerant.

14. The heat pump system of claim 1, further comprising:
a fifth connection line including:
a first end connected to the refrigerant line which is disposed between the third heat-exchanger and the compressor, and
a second end connected to the refrigerant line which is disposed between the first heat-exchanger and the second heat-exchanger; and
a third valve provided on the fifth connection line.

15. The heat pump system of claim 1, further comprising:
an accumulator provided on the refrigerant line which is disposed between the third heat-exchanger and the compressor; and
an internal heat-exchanger provided in an interior of the accumulator and configured to heat-exchange the refrigerant supplied from the second heat-exchanger and the refrigerant supplied from the third heat-exchanger with each other, and to supply a higher-temperature refrigerant among the heat-exchanged refrigerant to the third heat-exchanger.

16. The heat pump system of claim 1, wherein the second heat-exchanger and the third heat-exchanger are configured to cool or evaporate an interiorly introduced refrigerant.

17. The heat pump system of claim 1, wherein:
a first end of the first connection line is connected to the refrigerant line which is disposed between the second heat-exchanger and the first expansion valve; and
a second end of the first connection line is connected to the refrigerant line which is disposed between the third heat-exchanger and the compressor.

18. The heat pump system of claim 1, wherein the refrigerant is an R744 refrigerant formed of carbon dioxide.

19. The heat pump system of claim 1, wherein the chiller is respectively connected to an electrical component and a battery module through a first line and a second line through which the coolant circulates.

20. The heat pump system of claim 1, wherein:
the first heat-exchanger, the second heat-exchanger, and the third heat-exchanger are air-cooled gas coolers configured to heat-exchange an interiorly introduced refrigerant with air; and
the chiller is a water-cooled gas cooler configured to heat-exchange the interiorly introduced refrigerant with the coolant.
